(19) United States
(12) Patent Application Publication
(10) Pub. No.: US 2016/0250982 A1
(43) Pub. Date: Sep. 1, 2016

(54) THIN LAMINATE STRUCTURES WITH ENHANCED ACOUSTIC PERFORMANCE

(71) Applicant: CORNING INCORPORATED, Corning, NY (US)

(72) Inventors: William Keith Fisher, Suffield, CT (US); Michael John Moore, Corning, NY (US); Steven Luther Moyer, Lancaster, PA (US)

(21) Appl. No.: 15/054,228

(22) Filed: Feb. 26, 2016

Related U.S. Application Data
(60) Provisional application No. 62/121,076, filed on Feb. 26, 2015.

(51) Int. Cl. B60R 13/08; B32B 17/06; G10K 11/16

(52) U.S. Cl. CPC B60R 13/08; G10K 11/16; B32B 17/06; B32B 2307/102; B32B 2605/08; B32B 2607/00

(57) ABSTRACT

Embodiments of a laminate exhibiting enhanced acoustic performance are described. In one or more embodiments, the laminate includes a first substrate, an interlayer structure and a second substrate. One or both the first substrate and the second substrate have a thickness less than about 1.5 mm. In one or more embodiments, the interlayer structure includes a first interlayer and a second interlayer, wherein the first interlayer has a lower shear modulus than the second interlayer and is positioned near the center of the laminate (i.e., positioned at a thickness range from about 0.4t to about 0.6t, where t is the laminate thickness). The laminates exhibit a transmission loss of greater than about 38 dB over a frequency range from about 2500 Hz to about 6000 Hz. Vehicles and architectural panels including the laminates described herein are also provided.

### CROSS-REFERENCE TO RELATED APPLICATIONS

This application claims the benefit of priority under 35 U.S.C. §119 of U.S. Provisional Application Ser. No. 62/121,076 filed on Feb. 26, 2015 the content of which is relied upon and incorporated herein by reference in its entirety.

### BACKGROUND

The disclosure relates generally to thin laminated structures having improved acoustic properties and vehicles and architectural panels that incorporate such structures.

Laminates can be used as windows and glazing in architectural and transportation applications (e.g., vehicles including automobiles and trucks, rolling stock, locomotive and airplanes). Laminates can also be used as panels in balustrades and stairs, and as decorative panels or covering for walls, columns, elevator cabs, kitchen appliances and other applications. The laminates may be transparent, semi-transparent, translucent or opaque and may comprise part of a window, panel, wall, enclosure, sign or other structure. Common types of such laminates may also be tinted or colored or include a component that is tinted or colored.

Conventional vehicle laminate constructions may consist of two plies of 2 mm soda lime glass (heat treated or annealed) with a polyvinyl butyral PVB interlayer. These laminate constructions have limited impact resistance, and usually have a poor breakage behavior and a higher probability of breakage when getting struck by impacts such as roadside stones, vandals and others.

In many transportation applications, fuel economy is a function of vehicle weight. It is desirable, therefore, to reduce the weight of laminates for such applications without compromising their strength and sound-attenuating properties. In view of the foregoing, thinner laminates that possess or exceed the durability, sound-damping and breakage performance properties associated with thicker, heavier laminates are desirable.

### SUMMARY

A first aspect of this disclosure pertains to a thin laminate exhibiting improved acoustic performance. In one or more embodiments, the laminate exhibits a transmission loss of greater than about 38 dB over a frequency range from about 2500 Hz to about 6000 Hz. In some embodiments, the laminate exhibits a transmission loss of greater than 40 dB over a frequency range from about 4000 Hz to about 6000 Hz.

In one or more embodiments, the laminate includes a first substrate, an interlayer structure and a second substrate. In one or more embodiments, the laminate is positioned so the first substrate faces the sound source. For example, when the laminate is assembled in an opening of a vehicle (as shown in FIG. 1), the first substrate faces the exterior of the vehicle and faces the sound source from outside the vehicle, while the second substrate faces in the interior of the vehicle (away from the exterior sound). In one or more alternative embodiments, the laminate may be positioned so the second substrate faces the sound source. The interlayer structure is disposed between the first and second substrates and may include at least two interlayers. In one or more embodiments, the first interlayer has a shear modulus that is relatively lower than the shear modulus of the second interlayer. In some examples, the first interlayer has a shear modulus of 40×10⁶ Pa or less, at 30° C. and a frequency of 5000 Hz. The position of the first interlayer may be near the center of the laminate, which may be described in terms of the laminate thickness t (i.e., the center may be described as about 0.5 t). Accordingly, in some embodiments, the first interlayer is positioned at the thickness range from about 0.4 t to about 0.6 t. In some embodiments, the first interlayer is also positioned between the first substrate and the second interlayer, and the second interlayer is disposed between the first interlayer and the second substrate, if the first substrate is thicker than the second substrate. The thickness of the interlayer structure may be about 2.5 mm or less.

In one or more embodiments, the first interlayer and the second interlayer have different thicknesses from one another. The interlayer structure may include a third interlayer that may be disposed between the first substrate and the first interlayer. The third interlayer may have a shear modulus that is greater than the shear modulus of the first interlayer. The third interlayer may have a different thickness than the second interlayer. The third interlayer may also have a different shear modulus than the second interlayer.

In one or more embodiments, the interlayer structure may have a wedged shape in which the thickness at one minor surface is greater than the thickness at an opposing minor surface.

In one or more embodiments, either one or both the first substrate and the second substrate have a thickness of less than about 1.5 mm. In some embodiments, the first substrate may have a thickness of 2.5 mm or less, or about 1.8 mm or less. In some embodiments, the second substrate may include a thickness of about 0.7 mm or less. In one or more embodiments, the ratio of the thickness of the second substrate to the thickness of the first substrate is greater than about 0.2, about 0.33 or greater, about 0.39 or greater or about 0.5 or greater.

The first substrate and/or the second substrate may be strengthened or unstrengthened, as described herein. In some embodiments, the first substrate includes a soda lime glass. In embodiments where the first and/or second substrate is strengthened, such substrates may exhibit a compressive stress in the range from about 50 MPa to about 800 MPa, and a depth of compression from about 35 micrometers to about 200 micrometers.

The laminates described herein may be used in vehicles or architectural panels. In one or more embodiments, the laminate may be disposed in an opening of a vehicle body. Where the vehicle body is an automobile, the laminate could be used as a windshield, a side window, sunroof or rear windshield. The body of some embodiments may include railcar body, or an airplane body. In other embodiments, the laminate may be used in architectural panels, which may include a window, an interior wall panel, a modular furniture panel, a backsplash, a cabinet panel, or an appliance panel.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a perspective view of a vehicle according to one or more embodiments;

FIG. 2 is a side view of a laminate according to one or more embodiments;

FIG. 3 is a side view of a laminate according to one or more embodiments;

FIG. 4 is a side view of a laminate according to one or more embodiments;

FIG. 5 is a side view of a laminate according to one or more embodiments;

FIG. 6 is a side view of a laminate according to one or more embodiments;

FIG. 7 is a graph comparing the transmission loss of laminates according to one or more embodiments and known laminates as a function of frequency (Hz);

FIG. 8 is a graph comparing the mechanical deflection of Examples 2A-2G and Comparative Examples 2H-2K;

FIG. 9 is a graph showing the deflection (in mm) of Examples 2L-2O;

FIG. 10 is a graph showing sound transmission loss for Examples 3A and 3B;

FIG. 11 is a graph showing sound transmission loss for Examples 3C and 3D;

FIG. 12 is a graph showing sound transmission loss for Examples 4A and 4B;

FIG. 13 is a graph showing sound transmission loss for Examples 4C and 4D;

FIG. 14 is a graph showing sound transmission loss for Examples 5A-5C; and

FIG. 15 is a graph showing sound transmission loss for Examples 5D-5E.

### DETAILED DESCRIPTION

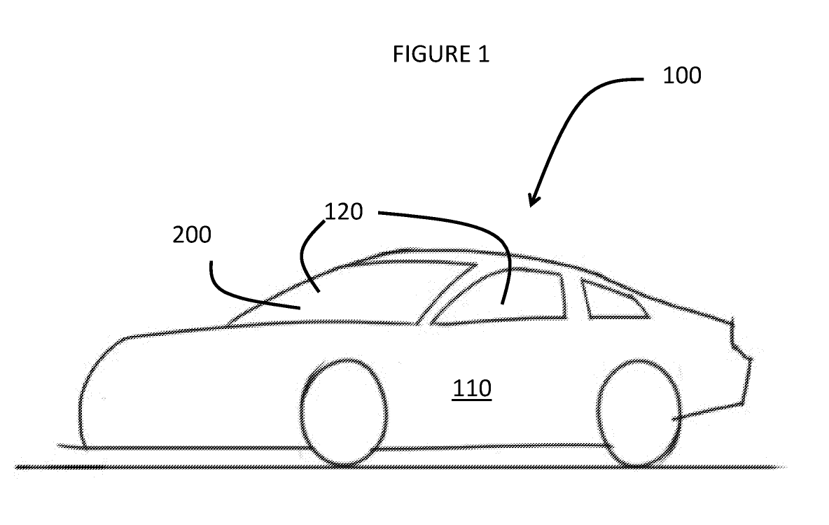

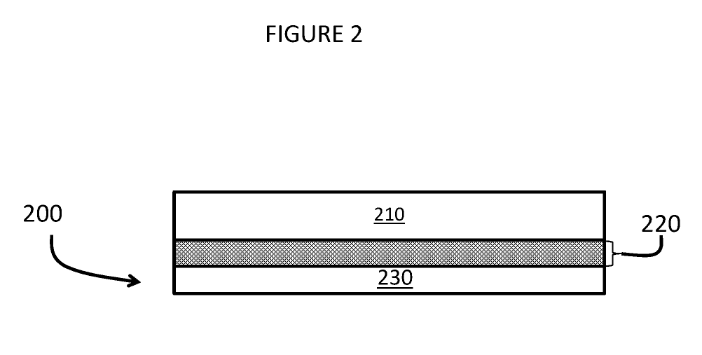

Reference will now be made in detail to the present preferred embodiment(s), examples of which are illustrated in the accompanying drawings. Aspects of this invention pertain to thin laminated or laminate structures having improved acoustic properties and vehicles and architectural panels that incorporate such structures. An example of a vehicle 100 that includes such a laminate structure 200 is shown in FIG. 1. The vehicle includes a body 110 with at least one opening 120. The laminate 200 is disposed in the at least one opening 120. As used herein, the term “vehicle” may include automobiles (e.g., cars, vans, trucks, semi-trailer trucks, and motorcycles), rolling stock, locomotives, train cars, airplanes, and the like. The opening 120 is a window within which a laminate is disposed to provide a transparent covering. It should be noted that the laminates described herein may be used in architectural panels such as windows, interior wall panels, modular furniture panels, backsplashes, cabinet panels, and/or appliance panels. Referring to FIG. 2, the laminate 200 of one or more embodiments includes a first substrate 210 and an interlayer structure 220. The interlayer structure 220 in such embodiments may be constrained by another layer. In some embodiments, such as the embodiment shown in FIG. 2, the laminate 200 includes a second substrate 230 such that the interlayer structure 220 is disposed between the first substrate 210 and the second substrate 230.

The acoustic performance of or degree of sound attenuation by a laminate (either alone or when assembled in a vehicle or architectural panel) may be measured by transmission loss, which depends on frequency. The frequency range from about 2500 Hz to about 6000 Hz is especially important for sounds heard by the human ear. Accordingly, increasing the transmission loss and thus improving the acoustic performance with respect to a vehicle or architectural panel over this frequency range is useful.

In some embodiments, the laminate exhibits a transmission loss of greater than about 38 dB (e.g., 39 dB or greater, 40 dB or greater, 41 dB or greater, or 42 dB or greater) over a frequency range from about 2500 Hz to about 6000 Hz. In some embodiments, the transmission loss is even greater over specific frequency ranges. For example, over the frequency range from about 4000 Hz to about 6000 Hz, the laminate exhibits a transmission loss of greater than 40 dB.

Referring to the construction of the laminate 200, the first and second substrates 210, 230 may have the same thickness or differing thicknesses. In FIG. 2, the first substrate 210 is shown having a greater thickness than the second substrate 230. In some embodiments, the thickness of the first substrate 210 may be in the range from about 0.3 mm to about 4 mm (e.g., from about 0.4 mm to about 4 mm, from about 0.5 mm to about 4 mm, from about 0.55 mm to about 4 mm, from about 0.6 mm to about 4 mm, from about 0.7 mm to about 4 mm, from about 0.8 mm to about 1 mm, from about 0.9 mm to about 4 mm, from about 1 mm to about 4 mm, from about 1.2 mm to about 4 mm, from about 1.5 mm to about 4 mm, from about 1.8 mm to about 4 mm, from about 2 mm to about 4 mm, from about 2.1 mm to about 4 mm, from about 2.5 mm to about 4 mm, from about from about 1 mm to about 4 mm, from about 0.3 mm to about 3 mm, from about 0.3 mm to about 2.1 mm, from about 0.3 mm to about 2 mm, from about 0.3 mm to about 1.8 mm, from about 0.3 mm to about 1.5 mm, from about 0.3 mm to about 1 mm, from about 0.3 mm to about 0.7 mm, or from about 1.2 mm to about 1.8 mm, and all ranges and sub-ranges therebetween).

In one or more embodiments, the thickness of the second substrate 230 may be less than the thickness of the first substrate 210. In some embodiments, the second substrate 230 is about 1 mm or less, 0.7 mm or less, 0.5 mm or less or about 0.4 mm or less. In some embodiments, the thickness of the second substrate 230 may be in the range from about 0.3 mm to about 4 mm (e.g., from about 0.4 mm to about 4 mm, from about 0.5 mm to about 4 mm, from about 0.55 mm to about 4 mm, from about 0.6 mm to about 4 mm, from about 0.7 mm to about 4 mm, from about 0.8 mm to about 1 mm, from about 0.9 mm to about 4 mm, from about 1 mm to about 4 mm, from about 1.2 mm to about 4 mm, from about 1.5 mm to about 4 mm, from about 1.8 mm to about 4 mm, from about 2 mm to about 4 mm, from about 2.1 mm to about 4 mm, from about 2.5 mm to about 4 mm, from about from about 1 mm to about 4 mm, from about 0.3 mm to about 3 mm, from about 0.3 mm to about 2.1 mm, from about 0.3 mm to about 2 mm, from about 0.3 mm to about 1.8 mm, from about 0.3 mm to about 1.5 mm, from about 0.3 mm to about 1 mm, from about 0.3 mm to about 0.7 mm, and all ranges and sub-ranges therebetween).

In embodiments in which the first substrate 210 has a thickness greater than the second substrate, the second substrate may have a thickness of about 1.5 mm or less, about 1 mm or less or about 0.7 mm or less. The difference in thickness between the first substrate 210 and the second substrate 230 may be about 0.5 mm or greater, 0.7 mm or greater, 0.8 mm or greater, 1 mm or greater or about 1.4 mm or greater. Some exemplary thickness combinations for the first substrate 210 and the second substrate 230 may be (written in the form of first substrate thickness in millimeters/second substrate thickness in millimeters) 2.1/1.8, 2.1/1.5, 2.1/1, 2.1/0.7, 2.1/0.55, 2.1/0.4, 1.8/1.8, 1.8/1.5, 1.8/1, 1.8/0.7, 1.8/0.55, 1.8/0.4, 1.5/1.5, 1.5/1, 1.5/0.7, 1.5/0.55, 1.5/0.4, 1/1, 1/0.7, 1/0.55, 1/0.4, 0.7/0.7, 0.7/0.55, 0.55/0.55, 0.55/0.5, 0.55/0.4, 0.5/0.5, 0.5/0.4, and 0.4/0.4.

The thickness of the first substrate 210 and the second substrate 230 may be described by a ratio. In some embodiments, the ratio of the thickness of the second substrate to the thickness of the first substrate is about 0.2 or greater, about 0.33 or greater. In some cases the ratio may be about 0.35 or greater, 0.37 or greater, 0.39 or greater, 0.4 or greater, 0.42 or greater, 0.44 or greater, 0.46 or greater, 0.48 or greater, about 0.5 or greater, or about 0.55 or greater. The upper limit of the ratio of the thickness of the second substrate to the thickness of the first substrate may be about 1. In some embodiments, the first and second substrates 210, 230 may each have a thickness of about 1.5 mm or less, 1 mm or less, or even 0.7 mm or less, and still exhibit a ratio that is greater than 0.2 or greater than 0.33. In one or more embodiments, such thin laminates may still exhibit the transmission loss performance described herein at frequencies of about 2500 Hz or greater.

The interlayer structure 220 disposed between the first substrate 210 and the second substrate 230 may have a thickness of 4 mm or less, about 3 mm or less, about 2 mm or less, or about 1 mm or less. In some embodiments, the thickness of the interlayer structure 220 may be in the range from about 0.5 mm to about 2.5 mm, from about 0.8 mm to about 2.5 mm, from about 1 mm to about 2.5 mm or from about 1.5 mm to about 2.5 mm.

The thickness of the interlayer structure 220 may be described with respect to the laminate thickness or the total substrate thickness (i.e., the combined thicknesses of the first substrate 210 and the second substrate 230). For example in some instances, exemplary ratios of the interlayer structure 220 thickness (in millimeters) to the total substrate thickness (in millimeters) may include 1.5/0.8 and 1/4.

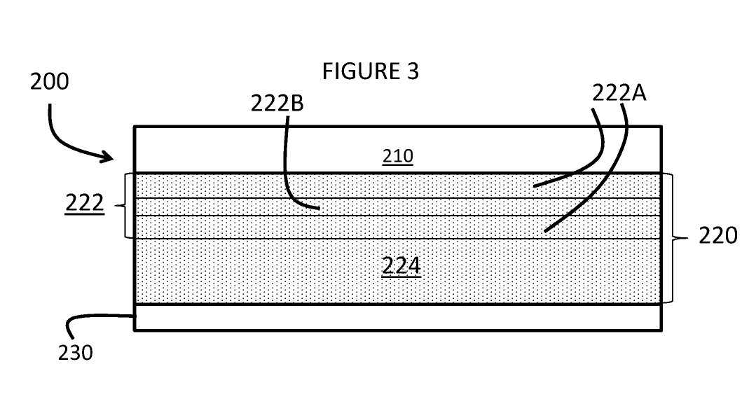

The interlayer structure 220 may include more than one interlayer. For example, two or more interlayers or three or more interlayers may be used to form the interlayer structure. In the embodiment shown in FIG. 3, the interlayer structure includes a first interlayer 222 and a second interlayer 224. The first interlayer 222 exhibits a shear modulus that is less than the shear modulus of the second interlayer 224. In some embodiments, the arrangement of the first interlayer 222 and the second interlayer 224 is such that the second interlayer (with a shear modulus that is greater than the shear modulus of the first interlayer) is in contact with or immediately adjacent to the thinner of the first substrate 210 and the second substrate 230. Accordingly, if the second substrate 230 is thinner than the first substrate 210, then the second interlayer 224 is in contact with or immediately adjacent to the second substrate 230, as shown in FIG. 3.

Without being bound by theory, the placement of the first interlayer 222 (with a lower shear modulus relative to the second interlayer 224) toward the center of the laminate contributes to the improved acoustic performance of the laminate. The center of the laminate may be described as 0.5 t, where t represents the thickness of the laminate. Accordingly, in some embodiments, the first interlayer (with a lower shear modulus relative to the second interlayer) may be positioned within the laminate such that it is closer in position to the substrate facing the source of sound. In some embodiments, the position of the first interlayer 222 is within a thickness range from about 0.2 t to about 0.8 t, or from about 0.4 t to about 0.6 t of the laminate.

In one or more embodiments, the substrate facing the source of sound is thinner (or has a lower thickness) than the opposing substrate. For example, in one or more embodiments, the first interlayer (with a lower shear modulus relative to the second interlayer) may be adjacent to or closer in position to the first substrate 210, which faces the source of sound. In a more specific embodiment, the first substrate 210 and may be thinner than the second substrate 230. In an alternative embodiment, the first substrate 210 may be thicker than the second substrate. In one or more embodiments, the laminate may be positioned in a vehicle opening such that the first substrate 210 faces the exterior of the vehicle and thus the source of sound and may be thinner than the second substrate 230. In such an embodiment, the first interlayer is closer to the first substrate 210 than the second substrate 230.

In one or more embodiments, the laminate may be positioned in a vehicle opening such that the second substrate 230 faces the exterior of the vehicle and thus the source of sound and may be thicker than the first substrate 210. In such an embodiment, the first interlayer is closer to the second substrate 230 than the first substrate 210.

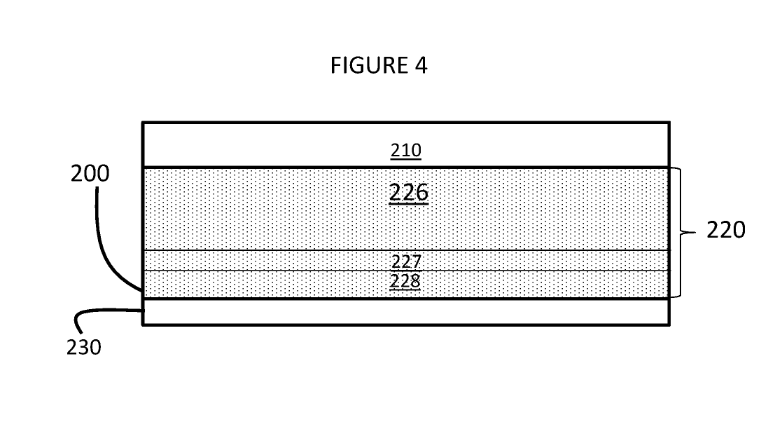

This understanding can be applied to an interlayer structure 220 with three or more interlayers. Moreover, two-interlayer, three-interlayer or other constructions of the interlayer structure 220 may be tuned to provide a lower shear modulus interlayer at or near the center of the laminate. This may be achieved by varying the thicknesses of the interlayers with respect to one another and taking into account the shear modulus of each interlayer. For example, as shown in FIG. 4, a three-layer interlayer structure 220 may be configured to exhibit a lower modulus through arrangement of the interlayers such that an outer interlayer is much thicker than the center interlayer and the opposite outer interlayer (e.g., outer interlayer 226 having a relatively higher shear modulus may have a thickness of about 1.14 mm, center interlayer 227 having a relatively lower shear modulus may have a thickness of about 0.05 mm, and outer interlayer 228 having a relatively higher shear modulus may have a thickness of about 0.38 mm). The shear modulus of all three interlayers may differ from one another. Alternatively, at least two of the interlayers may have the same shear modulus, which differs from the shear modulus of the third interlayer.

In one or more alternative embodiments, the second interlayer (having a relatively higher shear modulus than the first interlayer) may be positioned near the center of the laminate. Accordingly, in some embodiments, the second interlayer (with a greater shear modulus relative to the second interlayer) may be positioned within the laminate at a thickness range from about 0.25 t to about 0.75 t, or from about 0.4 t to about 0.6 t.

In one or more embodiments, the interlayer structure 220 includes two or more interlayers, where the first interlayer (having a shear modulus that is less than the shear modulus of the second interlayer) and the second interlayer have different thicknesses from one another. In some embodiments, a third interlayer may be included that has a different thickness from the second interlayer and optionally also the first interlayer.

In one or more embodiments the first interlayer 222, having a relatively lower shear modulus than the shear modulus of the second interlayer may include more than one sub-layer. As shown in FIG. 3, in one or more embodiments, the first interlayer 222 may include two outer sub-layers 222A having a relatively higher shear modulus (e.g., a shear modulus that is approximately equal to the shear modulus of the second interlayer 224), and a core or center sub-layer 222B that has a low shear modulus relative to the outer sub-layers (e.g., less than about 30×10⁶ Pa, at 30° C. and 5000 Hz). The first interlayer 222 has a shear modulus, taking into account the shear modulus values of each sub-layer and the relative thicknesses of each sub-layer, in the range from about 5×10⁶ Pa to about 40×10⁶ Pa, at 30° C. and a frequency of 5000 Hz. In some embodiments, the shear modulus of the first interlayer 222 may be in the range from about 7×10⁶ Pa to about 40×10⁶ Pa, from about 10×10⁶ Pa to about 40×10⁶ Pa, from about 15×10⁶ Pa to about 40×10⁶ Pa, from about 20×10⁶ Pa to about 40×10⁶ Pa, from about 5×10⁶ Pa to about 35×10⁶ Pa, from about 5×10⁶ Pa to about 30×10⁶ Pa, from about 5×10⁶ Pa to about 25×10⁶ Pa, or from about 5×10⁶ Pa to about 20×10⁶ Pa, all at 30° C. and a frequency of 5000 Hz. In some embodiments, the first interlayer may have a first outer sub-layer 222A having a thickness in the range from about 0.3 mm to about 0.4 mm, a center sub-layer 222B (having a low shear modulus relative to the outer sub-layers) having a thickness in the range from about 0.08 mm to about 0.15 mm, and a second outer sub-layer 222A having a thickness in the range from about 0.3 mm to about 0.4 mm.

The second interlayer 224 may have a relatively greater shear modulus, when compared to the first interlayer 222. For example, in some embodiments, the second interlayer has a shear modulus in the range from about 70×10⁶ Pa to about 150×10⁶ Pa, at 30° C. and a frequency of 5000 Hz. In one or more embodiments, the second interlayer 224 may have a shear modulus in the range from about 80×10⁶ Pa to about 150×10⁶ Pa, from about 90×10⁶ Pa to about 150×10⁶ Pa, from about 100×10⁶ Pa to about 110×10⁶ Pa, from about 70×10⁶ Pa to about 120×10⁶ Pa, from about 70×10⁶ Pa to about 140×10⁶ Pa, from about 70×10⁶ Pa to about 130×10⁶ Pa, from about 70×10⁶ Pa to about 120×10⁶ Pa, from about 70×10⁶ Pa to about 110×10⁶ Pa, or from about 70×10⁶ Pa to about 100×10⁶ Pa, all at 30° C. and a frequency of 5000 Hz.

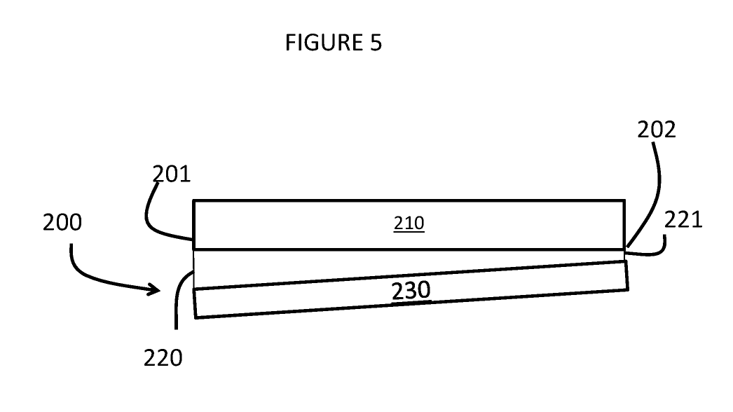

As shown in FIG. 5, the interlayer structure 221 of one or more embodiments may have a wedged shape in which the thickness at one minor surface 201 is greater than the thickness at an opposing minor surface 202. In one or more embodiments, the resulting laminate that includes such a wedge-shaped interlayer structure 221 may be utilized in a heads-up display to minimize or eliminate optical defects due to reflections created by the substrates and interlayer structure. In one or more embodiments, the resulting laminate would have improved acoustic properties, as described herein.

The interlayer structure 220, the individual layers and/or the sub-layers of the interlayer structure 220 may be formed from a variety of materials. In one or more embodiments, the interlayer structure 220, the individual layers and/or the sub-layers of the interlayer structure 220 may be formed from polymers such as polyvinyl butyral (PVB), ethylene-vinyl acetate (EVA) and thermoplastic polyurethane (TPU), polyester (PE), polyethylene terephthalate (PET) and the like. The interlayer structure 220, the individual layers and/or the sub-layers of the interlayer structure 220 may include any one or more of pigments, UV absorbers, infrared absorbers, adhesion control salts, and other stabilizers.

The laminate 200 thickness may be about 7 mm or less, 6 mm or less, or 5 mm or less. In some embodiments, the laminate 200 thickness may be in the range from about 2 mm to about 7 mm, from about 2 mm to about 6.5 mm, from about 2 mm to about 6 mm, from about 2 mm to about 5.5 mm, from about 2 mm to about 5 mm, from about 2 mm to about 4.5 mm, from about 2 mm to about 4 mm, from about 2.2 mm to about 7 mm, from about 2.5 mm to about 7 mm, from about 2.7 mm to about 7 mm, from about 3 mm to about 7, from about 3.2 mm to about 7, from about 3.4 mm to about 7, from about 3.6 mm to about 7, from about 3.8 mm to about 7, from about 3 mm to about 6, from about 3 mm to about 5, from 2 mm to about to about 3.8 mm, from about 2 mm to about 3.6 mm, from about 2 mm to about 3.4 mm, from about 2 mm to about 3.2 mm, from about 2 mm to about 3 mm and all ranges and sub-ranges therebetween.

The laminate 200 of one or more embodiments may exhibit a relatively low deflection stiffness, compared to other laminates exhibiting acoustic dampening, at room temperature. In one or more embodiments, the laminate 200 may exhibit a deflection stiffness of less than about 150 N/cm at room temperature. This deflection stiffness is measured before the laminate is shaped or otherwise bent (i.e., the laminate is planar and flat). The deflection stiffness may be measured using a three-point bend test. Without being bound by theory, it is believed that the increase in flexibility (or decrease in deflection stiffness) facilitates shearing between at least the first interlayer and the other substrates and/or layers of the laminate.

In one or more embodiments, the laminate may be characterized in terms of optical properties. In one or more embodiments, the laminate may be transparent and exhibit an average transmittance in the range from about 50% to about 90%, over a wavelength range from about 380 nm to about 780 nm. As used herein, the term “transmittance” is defined as the percentage of incident optical power within a given wavelength range transmitted through a material (e.g., the article, the substrate or the optical film or portions thereof). The term “reflectance” is similarly defined as the percentage of incident optical power within a given wavelength range that is reflected from a material (e.g., the article, the substrate, or the optical film or portions thereof). Transmittance and reflectance are measured using a specific linewidth. In one or more embodiments, the spectral resolution of the characterization of the transmittance and reflectance is less than 5 nm or 0.02 eV.

Optionally, the laminate may be characterized as translucent or opaque. In one or more embodiments, the laminate may exhibit an average transmittance in the range from about 0% to about 40%, over about over a wavelength range from about 380 nm to about 780 nm.

The color exhibited by the laminate in reflection or transmittance may also be tuned to the application. In one or more embodiments, the potential colors may include grey, bronze, pink, blue, green and the like. The color may be imparted by the substrates 210, 230 or by the interlayer structure 220. Such colors do not impact the acoustic performance of the laminate and vice versa.

In one or more embodiments, the acoustic performance of the laminates described herein is achievable while also exhibiting low or no optical distortion. In other words, the laminates provided herein simultaneously exhibit the improved acoustic performance and exhibit low or no optical distortion that can arise during manufacture.

The materials used in the laminate may vary according to application or use. In one or more embodiments, the substrate 210, 230 may be characterized as having a greater modulus than the interlayers. In some embodiments, the first and second substrates 210, 230 may be described as inorganic and may include an amorphous substrate, a crystalline substrate or a combination thereof. Either one or both the first and second substrates 210, 230 may be formed from man-made materials and/or naturally occurring materials. In some specific embodiments, the substrate 210,230 may specifically exclude plastic and/or metal substrates.

In some embodiments, either one or both of the first and second substrates 210, 230 may be organic and specifically polymeric. Examples of suitable polymers include, without limitation: thermoplastics including polystyrene (PS) (including styrene copolymers and blends), polycarbonate (PC) (including copolymers and blends), polyesters (including copolymers and blends, including polyethyleneterephthalate and polyethyleneterephthalate copolymers), polyolefins (PO) and cyclicpolyolefins (cyclic-PO), polyvinylchloride (PVC), acrylic polymers including polymethyl methacrylate (PMMA) (including copolymers and blends), thermoplastic urethanes (TPU), polyetherimide (PEI) and blends of these polymers with each other. Other exemplary polymers include epoxy, styrenic, phenolic, melamine, and silicone resins.

In one or more embodiments, either one or both of the first and second substrates 210, 230 exhibits a refractive index in the range from about 1.45 to about 1.55. In specific embodiments, either one or both of the first and second substrates 210, 230 may exhibit an average strain-to-failure at a surface on one or more opposing major surface that is 0.5% or greater, 0.6% or greater, 0.7% or greater, 0.8% or greater, 0.9% or greater, 1% or greater, 1.1% or greater, 1.2% or greater, 1.3% or greater, 1.4% or greater 1.5% or greater or even 2% or greater, as measured using ball-on-ring testing using at least 5, at least 10, at least 15, or at least 20 samples. In specific embodiments, either one or both of the first and second substrates 210, 230 may exhibit an average strain-to-failure at its surface on one or more opposing major surface of about 1.2%, about 1.4%, about 1.6%, about 1.8%, about 2.2%, about 2.4%, about 2.6%, about 2.8%, or about 3% or greater.

Either one or both of the first and second substrates 210, 230 may exhibit an elastic modulus (or shear modulus) in the range from about 30 GPa to about 120 GPa. In some instances, the elastic modulus of either one or both of the first and second substrates 210, 230 may be in the range from about 30 GPa to about 110 GPa, from about 30 GPa to about 100 GPa, from about 30 GPa to about 90 GPa, from about 30 GPa to about 80 GPa, from about 30 GPa to about 70 GPa, from about 40 GPa to about 120 GPa, from about 50 GPa to about 120 GPa, from about 60 GPa to about 120 GPa, from about 70 GPa to about 120 GPa, and all ranges and sub-ranges therebetween.

In one or more embodiments, either one or both of the first and second substrates 210, 230 may be amorphous and may include glass, which may be strengthened or non-strengthened. Examples of suitable glass include soda lime glass, alkali aluminosilicate glass, alkali containing borosilicate glass and alkali aluminoborosilicate glass. In some variants, the glass may be free of lithia. In one or more alternative embodiments, either one or both of the first and second substrates 210, 230 may include crystalline substrates such as glass ceramic substrates (which may be strengthened or non-strengthened) or may include a single crystal structure, such as sapphire. In one or more specific embodiments, the substrate 110 includes an amorphous base (e.g., glass) and a crystalline cladding (e.g., sapphire layer, a polycrystalline alumina layer and/or or a spinel (MgAl₂O₄) layer).

Either one or both of the first and second substrates 210, 230 may be substantially planar or sheet-like, although other embodiments may utilize a curved or otherwise shaped or sculpted substrate. Either one or both of the first and second substrates 210, 230 may be substantially optically clear, transparent and free from light scattering. In such embodiments, either one or both of the first and second substrates 210, 230 may exhibit an average transmittance over the wavelength range from about 420 nm to about 700 nm of about 85% or greater, about 86% or greater, about 87% or greater, about 88% or greater, about 89% or greater, about 90% or greater, about 91% or greater or about 92% or greater. In one or more alternative embodiments, either one or both of the first and second substrates 210, 230 may be opaque or exhibit an average transmittance over the wavelength range from about 420 nm to about 700 nm of less than about 10%, less than about 9%, less than about 8%, less than about 7%, less than about 6%, less than about 5%, less than about 4%, less than about 3%, less than about 2%, less than about 1%, or less than about 0%. Either one or both of the first and second substrates 210, 230 may optionally exhibit a color or tint, such as white, black, red, blue, green, yellow, orange etc.

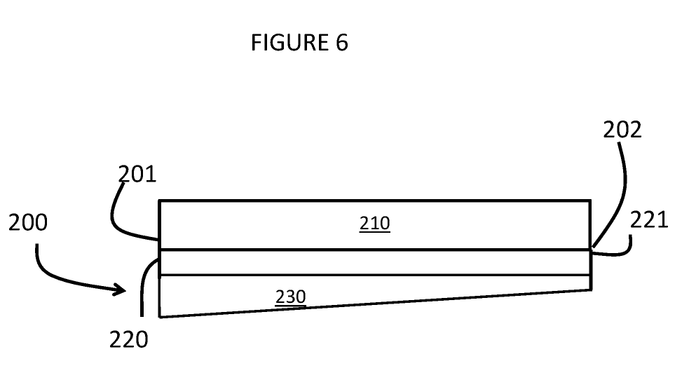

Additionally or alternatively, the physical thickness of either one or both of the first and second substrates 210, 230 may vary along one or more of its dimensions for aesthetic and/or functional reasons. For example, one or more of the edges of a substrate may be thicker as compared to more central regions. In one example, the first substrate 210 or the second substrate 230 may have a wedged shape. FIG. 6 shows a side view of a laminate 200 of one or more embodiments in which the second substrate 230 has a wedge shape in that the thickness of one minor surface 201 of the laminate is greater than the thickness at an opposing minor surface 202 of the laminate. The length, width and physical thickness dimensions of either one or both of the first and second substrates 210, 230 may also vary according to the application or use.

The substrate 210, 230 may be provided using a variety of different processes. For instance, where the substrate includes an amorphous substrate such as glass, various forming methods can include float glass processes and down-draw processes such as fusion draw and slot draw.

Once formed, either one or both of the first and second substrates 210, 230 may be strengthened to form a strengthened substrate. As used herein, the term “strengthened substrate” may refer to a substrate that has been chemically strengthened, for example through ion-exchange of larger ions for smaller ions in the surface of the substrate. However, other strengthening methods known in the art, such as thermal strengthening (i.e., by a rapid quench after heating), or mechanical strengthening (i.e., utilizing a mismatch of the coefficient of thermal expansion between portions of the substrate to create compressive stress and central tension regions), may be utilized to form strengthened substrates. In some embodiments, either one or both of the first and second substrates 210, 230 may be strengthened using a combination of methods including any two or more of chemical strengthening, thermally strengthening and mechanical strengthening methods. For example, either one or both of the first and second substrates 210, 230 may be thermally strengthened followed by chemically strengthened to form a thermally and chemically strengthened substrate.

Where a substrate is chemically strengthened by an ion exchange process, the ions in the surface layer of the substrate are replaced by—or exchanged with—larger ions having the same valence or oxidation state. Ion exchange processes are typically carried out by immersing a substrate in a molten salt bath containing the larger ions to be exchanged with the smaller ions in the substrate. It will be appreciated by those skilled in the art that parameters for the ion exchange process, including, but not limited to, bath composition and temperature, immersion time, the number of immersions of the substrate in a salt bath (or baths), use of multiple salt baths, additional steps such as annealing, washing, and the like, are generally determined by the composition of the substrate and the desired compressive stress (CS), and depth of compressive stress layer (DOC) of the substrate that result from the strengthening operation. By way of example, ion exchange of alkali metal-containing glass substrates may be achieved by immersion in at least one molten bath containing a salt such as, but not limited to, nitrates, sulfates, and chlorides of the larger alkali metal ion. The temperature of the molten salt bath typically is in a range from about 380° C. up to about 450° C., while immersion times range from about 15 minutes up to about 40 hours. However, temperatures and immersion times different from those described above may also be used.

In addition, non-limiting examples of ion exchange processes in which glass substrates are immersed in multiple ion exchange baths, with washing and/or annealing steps between immersions, are described in U.S. patent application Ser. No. 12/500,650, filed Jul. 10, 2009, by Douglas C. Allan et al., entitled “Glass with Compressive Surface for Consumer Applications” and claiming priority from U.S. Provisional Patent Application No. 61/079,995, filed Jul. 11, 2008, in which glass substrates are strengthened by immersion in multiple, successive, ion exchange treatments in salt baths of different concentrations; and U.S. Pat. No. 8,312,739, by Christopher M. Lee et al., issued on Nov. 20, 2012, and entitled “Dual Stage Ion Exchange for Chemical Strengthening of Glass,” and claiming priority from U.S. Provisional Patent Application No. 61/084,398, filed Jul. 29, 2008, in which glass substrates are strengthened by ion exchange in a first bath is diluted with an effluent ion, followed by immersion in a second bath having a smaller concentration of the effluent ion than the first bath. The contents of U.S. patent application Ser. No. 12/500,650 and U.S. Pat. No. 8,312,739 are incorporated herein by reference in their entirety.

In one or more embodiments, either one or both the first and second substrates 210, 230 may be thermally strengthening using conventional thermally strengthening processes that include heating the substrate in a radiant energy furnace or a convection furnace (or a “combined mode” furnace using both techniques) to a predetermined temperature, then gas cooling (“quenching”), typically via convection by blowing large amounts of ambient air against or along the glass surface. This gas cooling process is predominantly convective, whereby the heat transfer is by mass motion (collective movement) of the fluid, via diffusion and advection, as the gas carries heat away from the hot glass substrate.

In one or more embodiments, either one or both of the first and second substrates 210, 230 may be thermally strengthened using very high heat transfer rates. In particular embodiments, after heating the substrate as to a predetermined temperature, the thermal strengthening process may utilize a small-gap, gas bearing in the cooling/quenching section that allows processing thin glass substrates at higher relative temperatures at the start of cooling, resulting in higher thermal strengthening levels. This small-gap, gas bearing cooling/quenching section achieves very high heat transfer rates via conductive heat transfer to heat sink(s) across the gap, rather than using high air flow based convective cooling. This high rate conductive heat transfer is achieved while not contacting the glass with liquid or solid material, by supporting the glass on gas bearings within the gap.

The degree of strengthening achieved may be quantified based on the parameters of central tension (CT), surface CS, and either one or both of depth of compression (DOC) and depth of layer (DOL). It should be noted that DOL and DOC, as defined herein, are not always equal, especially where compressive stress extends to deeper depths of a substrate. As used herein, the terms “depth of compression” and “DOC” refer to the depth at which the stress within the glass-based article changes compressive to tensile stress. At the DOC, the stress crosses from a positive (compressive) stress to a negative (tensile) stress and thus exhibits a stress value of zero. DOL is distinguished from DOC by measurement technique in that DOL is determined by surface stress meter using commercially available instruments such as the FSM-6000, manufactured by Luceo Co., Ltd. (Tokyo, Japan) (“FSM”), or the like, and known techniques using the same (often referred to as FSM techniques). In some embodiments, DOL indicates the depth of the compressive stress layer achieved by chemical strengthening, whereas DOC indicates the depth of the compressive stress layer achieved by thermal strengthening and/or mechanical strengthening.

Surface CS may be measured near the surface or within the strengthened glass at various depths. A maximum CS value may include the measured CS at the surface (CSₛ) of the strengthened substrate. The CT, which is computed for the inner region adjacent the compressive stress layer within a glass substrate, can be calculated from the CS, the physical thickness t, and the DOL. CS may be measured using those means known in the art such as by the measurement of surface stress using an FSM or the like. Methods of measuring CS and DOL are described in ASTM 1422C-99, entitled “Standard Specification for Chemically Strengthened Flat Glass,” and ASTM 1279.19779 “Standard Test Method for Non-Destructive Photoelastic Measurement of Edge and Surface Stresses in Annealed, Heat-Strengthened, and Fully-Tempered Flat Glass,” the contents of which are incorporated herein by reference in their entirety. Surface stress measurements rely upon the accurate measurement of the stress optical coefficient (SOC), which is related to the birefringence of the glass substrate. SOC in turn is measured by those methods that are known in the art, such as fiber and four point bend methods, both of which are described in ASTM standard C770-98 (2008), entitled “Standard Test Method for Measurement of Glass Stress-Optical Coefficient,” the contents of which are incorporated herein by reference in their entirety, and a bulk cylinder method. The relationship between CS and CT is given by the expression (1):

CT=(CS·DOL)/(t−2DOL) (1),

wherein t is the physical thickness (μm) of the glass article. In various sections of the disclosure, CT and CS are expressed herein in megaPascals (MPa), physical thickness t is expressed in either micrometers (μm) or millimeters (mm) and DOL is expressed in micrometers (μm).

In one embodiment, a strengthened substrate can have a surface CS in the range from about 50 MPa to about 800 MPa (e.g., about 100 MPa or greater, about 150 MPa or greater, about 200 MPa or greater, of 250 MPa or greater, 300 MPa or greater, e.g., 400 MPa or greater, 450 MPa or greater, 500 MPa or greater, 550 MPa or greater, 600 MPa or greater, 650 MPa or greater, 700 MPa or greater, or 750 MPa or greater).

The strengthened substrate may have a DOL in the range from about 35 μm to about 200 μm (e.g., 45 μm, 60 μm, 75 μm, 100 μm, 125 μm, 150 μm or greater). In one or more specific embodiments, the strengthened substrate has one or more of the following: a surface CS of about 50 MPa to about 200 MPa, and a DOL in the range from about 100 μm to about 200 μm; a surface CS of about 600 MPa to about 800 MPa and a DOL in the range from about 35 μm to about 70 μm.

For strengthened glass-based articles in which the compressive stress layers extend to deeper depths within the glass-based article, the FSM technique may suffer from contrast issues which affect the observed DOL value. At deeper DOL values, there may be inadequate contrast between the TE and TM spectra, thus making the calculation of the difference between TE and TM spectra—and determining the DOL—more difficult. Moreover, the FSM technique is incapable of determining the compressive stress profile (i.e., the variation of compressive stress as a function of depth within the glass-based article). In addition, the FSM technique is incapable of determining the DOL resulting from the ion exchange of certain elements such as, for example, lithium.

The techniques described below have been developed to yield more accurately determine the depth of compression (DOC) and compressive stress profiles for strengthened glass-based articles.

In U.S. patent application Ser. No. 13/463,322, entitled “Systems And Methods for Measuring the Stress Profile of Ion-Exchanged Glass (hereinafter referred to as “Roussev I”),” filed by Rostislav V. Roussev et al. on May 3, 2012, and claiming priority to U.S. Provisional Patent Application No. 61/489,800, having the same title and filed on May 25, 2011, two methods for extracting detailed and precise stress profiles (stress as a function of depth) of tempered or chemically strengthened glass are disclosed. The spectra of bound optical modes for TM and TE polarization are collected via prism coupling techniques, and used in their entirety to obtain detailed and precise TM and TE refractive index profiles n_{TM}(z) and n_{TE}(z). The contents of the above applications are incorporated herein by reference in their entirety.

In one embodiment, the detailed index profiles are obtained from the mode spectra by using the inverse Wentzel-Kramers-Brillouin (IWKB) method.

In another embodiment, the detailed index profiles are obtained by fitting the measured mode spectra to numerically calculated spectra of pre-defined functional forms that describe the shapes of the index profiles and obtaining the parameters of the functional forms from the best fit. The detailed stress profile S(z) is calculated from the difference of the recovered TM and TE index profiles by using a known value of the stress-optic coefficient (SOC):

S(z)=[n_{TM}(z)−n_{TE}(z)]/SOC (2).

Due to the small value of the SOC, the birefringence n_{TM}(z)−n_{TE}(z) at any depth z is a small fraction (typically on the order of 1%) of either of the indices n_{TM}(z) and n_{TE}(z). Obtaining stress profiles that are not significantly distorted due to noise in the measured mode spectra requires determination of the mode effective indices with precision on the order of 0.00001 RIU. The methods disclosed in Roussev I further include techniques applied to the raw data to ensure such high precision for the measured mode indices, despite noise and/or poor contrast in the collected TE and TM mode spectra or images of the mode spectra. Such techniques include noise-averaging, filtering, and curve fitting to find the positions of the extremes corresponding to the modes with sub-pixel resolution.

Similarly, U.S. patent application Ser. No. 14/033,954, entitled “Systems and Methods for Measuring Birefringence in Glass and Glass-Ceramics (hereinafter “Roussev II”),” filed by Rostislav V. Roussev et al. on Sep. 23, 2013, and claiming priority to U.S. Provisional Application Ser. No. 61/706,891, having the same title and filed on Sep. 28, 2012, discloses apparatus and methods for optically measuring birefringence on the surface of glass and glass ceramics, including opaque glass and glass ceramics. Unlike Roussev I, in which discrete spectra of modes are identified, the methods disclosed in Roussev II rely on careful analysis of the angular intensity distribution for TM and TE light reflected by a prism-sample interface in a prism-coupling configuration of measurements. The contents of the above applications are incorporated herein by reference in their entirety.

Hence, correct distribution of the reflected optical intensity vs. angle is much more important than in traditional prism-coupling stress-measurements, where only the locations of the discrete modes are sought. To this end, the methods disclosed in Roussev 1 and Roussev II comprise techniques for normalizing the intensity spectra, including normalizing to a reference image or signal, correction for nonlinearity of the detector, averaging multiple images to reduce image noise and speckle, and application of digital filtering to further smoothen the intensity angular spectra. In addition, one method includes formation of a contrast signal, which is additionally normalized to correct for fundamental differences in shape between TM and TE signals. The aforementioned method relies on achieving two signals that are nearly identical and determining their mutual displacement with sub-pixel resolution by comparing portions of the signals containing the steepest regions. The birefringence is proportional to the mutual displacement, with a coefficient determined by the apparatus design, including prism geometry and index, focal length of the lens, and pixel spacing on the sensor. The stress is determined by multiplying the measured birefringence by a known stress-optic coefficient.

In another disclosed method, derivatives of the TM and TE signals are determined after application of some combination of the aforementioned signal conditioning techniques. The locations of the maximum derivatives of the TM and TE signals are obtained with sub-pixel resolution, and the birefringence is proportional to the spacing of the above two maxima, with a coefficient determined as before by the apparatus parameters.

Associated with the requirement for correct intensity extraction, the apparatus comprises several enhancements, such as using a light-scattering surface (static diffuser) in close proximity to or on the prism entrance surface to improve the angular uniformity of illumination, a moving diffuser for speckle reduction when the light source is coherent or partially coherent, and light-absorbing coatings on portions of the input and output facets of the prism and on the side facets of the prism, to reduce parasitic background which tends to distort the intensity signal. In addition, the apparatus may include an infrared light source to enable measurement of opaque materials.

Furthermore, Roussev II discloses a range of wavelengths and attenuation coefficients of the studied sample, where measurements are enabled by the described methods and apparatus enhancements. The range is defined by αₛλ<250πσₛ, where αₛ is the optical attenuation coefficient at measurement wavelength λ, and σₛ is the expected value of the stress to be measured with typically required precision for practical applications. This wide range allows measurements of practical importance to be obtained at wavelengths where the large optical attenuation renders previously existing measurement methods inapplicable. For example, Roussev II discloses successful measurements of stress-induced birefringence of opaque white glass-ceramic at a wavelength of 1550 nm, where the attenuation is greater than about 30 dB/mm.

While it is noted above that there are some issues with the FSM technique at deeper DOL values, FSM is still a beneficial conventional technique which may utilized with the understanding that an error range of up to +/−20% is possible at deeper DOL values. The terms “depth of layer” and “DOL” as used herein refer to DOL values computed using the FSM technique, whereas the terms “depth of compression” and “DOC” refer to depths of the compressive layer determined by the methods described in Roussev I & II. DOC and CT may also be measured using a scattered light polariscope (SCALP), using techniques known in the art.

The strengthened substrate may have a DOC in the range from about 35 μm to about 200 μm (e.g., 45 μm, 60 μm, 75 μm, 100 μm, 125 μm, 150 μm or greater). In one or more specific embodiments, the strengthened substrate has one or more of the following: a surface CS of about 50 MPa to about 200 MPa, and a DOC in the range from about 100 μm to about 200 μm; a surface CS of about 600 MPa to about 800 MPa and a DOC in the range from about 35 μm to about 70 μm.

Example glasses that may be used in the substrate may include alkali aluminosilicate glass compositions or alkali aluminoborosilicate glass compositions, though other glass compositions are contemplated. Such glass compositions are capable of being chemically strengthened by an ion exchange process. One example glass composition comprises SiO₂, B₂O₃ and Na₂O, where (SiO₂+B₂O₃)≧66 mol. %, and Na₂O≧9 mol. %. In an embodiment, the glass composition includes at least 6 wt. % aluminum oxide. In a further embodiment, the substrate includes a glass composition with one or more alkaline earth oxides, such that a content of alkaline earth oxides is at least 5 wt. %. Suitable glass compositions, in some embodiments, further comprise at least one of K₂O, MgO, and CaO. In a particular embodiment, the glass compositions used in the substrate can comprise 61-75 mol. % SiO2; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further example glass composition suitable for the substrate comprises: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. % (Li₂O+Na₂O+K₂O)≦20 mol. % and 0 mol. %≦(MgO+CaO)≦10 mol. %.

A still further example glass composition suitable for the substrate comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≦(Li₂O+Na₂O+K₂O)≦18 mol. % and 2 mol. % (MgO+CaO)≦7 mol. %.

In a particular embodiment, an alkali aluminosilicate glass composition suitable for the substrate comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio

$$\frac{{Al}_{2} {O}_{3} + {B}_{2} {O}_{3}}{Σ modifiers} > 1 ,$$

where in the ratio the components are expressed in mol. % and the modifiers are alkali metal oxides. This glass composition, in particular embodiments, comprises: 58-72 mol. % SiO₂; 9-17 mol. % Al₂O₃; 2-12 mol. % B₂O₃; 8-16 mol. % Na₂O; and 0-4 mol. % K₂O, wherein the ratio

$$\frac{{Al}_{2} {O}_{3} + {B}_{2} {O}_{3}}{Σ modifiers} > 1.$$

In still another embodiment, the substrate may include an alkali aluminosilicate glass composition comprising: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. %≦SiO₂+B₂O₃+CaO≦69 mol. %; Na₂O+K₂O+B₂O₃+MgO+CaO+SrO>10 mol. %; 5 mol. % MgO+CaO+SrO≦8 mol. %; (Na₂O+B₂O₃)−Al₂O₃ 2 mol. %; 2 mol. % Na₂O−Al₂O₃≦6 mol. %; and 4 mol. %≦(Na₂O+K₂O)−Al₂O₃≦10 mol. %.

In an alternative embodiment, the substrate may comprise an alkali aluminosilicate glass composition comprising: 2 mol % or more of Al₂O₃ and/or ZrO₂, or 4 mol % or more of Al₂O₃ and/or ZrO₂.

Where a substrate 210, 230 includes a crystalline substrate, the substrate may include a single crystal, which may include Al₂O₃. Such single crystal substrates are referred to as sapphire. Other suitable materials for a crystalline substrate include polycrystalline alumina layer and/or spinel (MgAl₂O₄).

Optionally, the crystalline substrate 210, 230 may include a glass ceramic substrate, which may be strengthened or non-strengthened. Examples of suitable glass ceramics may include Li₂O—Al₂O₃—SiO₂ system (i.e. LAS-System) glass ceramics, MgO—Al₂O₃—SiO₂ system (i.e. MAS-System) glass ceramics, and/or glass ceramics that include a predominant crystal phase including β-quartz solid solution, β-spodumene ss, cordierite, and lithium disilicate. The glass ceramic substrates may be strengthened using the chemical strengthening processes disclosed herein. In one or more embodiments, MAS-System glass ceramic substrates may be strengthened in Li₂SO₄ molten salt, whereby an exchange of 2Li⁺ for Mg²⁺ can occur.

In one or more embodiments, the first substrate is unstrengthened, while the second substrate is strengthened. In some embodiments, the first substrate may include a soda lime glass. Optionally, the first substrate may include a soda lime glass that is strengthened. In another embodiment, the first substrate may include an alkali aluminosilicate glass that is strengthened.

The substrate composition may include a colorant to provide darkening for privacy glass, and/or reducing the transmission of infrared radiation for solar glass.

The laminates described herein may include one or more films, coatings or surface treatments to provide added functionality. Examples of such films and/or coatings include anti-reflective coatings, UV absorbing coatings, IR reflecting coatings, anti-glare surface treatments, and the like.

The laminates described herein may be formed using known techniques in the art including hot bending (i.e., forming the substrates separately or together in a furnace or heated environment), cold forming (i.e., shaping at room temperature) and the like.

The laminate may be disposed in an opening of a vehicle or within an architectural panel by adhesives and other means to secure the laminate thereto.

### EXAMPLES

Various embodiments will be further clarified by the following examples.

### Example 1

Modeled Examples 1A-1C and Modeled Comparative Examples 1D-1H were evaluated and had the constructions shown in Table 1.

TABLE 1
Constructions of Examples 1A-1C and Comparative Examples 1D-1H.

| | Substrate | First interlayer | Second interlayer | |
|---|---|---|---|---|
| | (composition, | (shear modulus, | (shear modulus, | |
| Ex. | thickness) | thickness) | thickness) | Substrate |
| 1A | Soda lime glass, | 8.2 × 10⁶ Pa, at 20° | 1.3 × 10⁸, at 20° C. and | Alkali- |
| | 2.1 mm | C. and at 5000 Hz, | at 5000 Hz, 0.76 mm | aluminosilicate, |
| | (unstrengthened) | 0.81 mm | | 0.7 mm |
| | | | | (strengthened) |
| 1B | Soda lime glass, | 8.2 × 10⁶ Pa, at 5000 | 1.3 × 10⁸, at 20° C. and | Alkali- |
| | 1.8 mm | Hz at 20° C., 0.81 | at 5000 Hz, 0.76 mm | aluminosilicate, |
| | (unstrengthened) | mm | | 0.7 mm |
| | | | | (strengthened) |
| 1C | Soda lime glass, | 8.2 × 10⁶ Pa, at 5000 | 1.3 × 10⁸, at 20° C. and | Alkali- |
| | 1.8 mm | Hz at 20° C., 0.81 | at 5000 Hz, 0.76 mm | aluminosilicate, |
| | (unstrengthened) | mm | | 1 mm |
| | | | | (strengthened) |
| 1D | Soda lime glass, | 8.2 × 10⁶ Pa, at 5000 | None | Soda lime glass, |
| (comp.) | 2.1 mm | Hz at 20° C., 0.81 | | 2.1 mm |
| | (unstrengthened) | mm | | (unstrengthened) |
| 1E | Soda lime glass, | 8.2 × 10⁶ Pa, at 5000 | None | Alkali- |
| (comp.) | 2.1 mm | Hz at 20° C., 0.81 | | aluminosilicate, |
| | (unstrengthened) | mm | | 0.7 mm |
| | | | | (strengthened) |
| 1F | Soda lime glass, | 8.2 × 10⁶ Pa, at 5000 | 1.3 × 10⁸, at 20° C. and | Alkali- |
| (comp.) | 2.1 mm | Hz at 20° C., 0.81 | at 5000 Hz, 0.38 mm | aluminosilicate, |
| | (unstrengthened) | mm | | 0.5 mm |
| | | | | (strengthened) |
| 1G | Soda lime glass, | 8.2 × 10⁶ Pa, at 5000 | 1.3 × 10⁸, at 20° C. and | Alkali- |
| (comp.) | 2.1 mm | Hz at 20° C., 0.81 | at 5000 Hz, 0.81 mm | aluminosilicate, |
| | (unstrengthened) | mm | | 0.7 mm |
| | | | | (strengthened) |
| 1H | Soda lime glass, | 8.2 × 10⁶ Pa, at 5000 | 1.3 × 10⁸, at 20° C. and | Alkali- |
| (comp.) | 2.1 mm | Hz at 20° C., 0.81 | at 5000 Hz, 0.38 mm | aluminosilicate, |
| | (unstrengthened) | mm | | 0.7 mm |
| | | | | (strengthened) |

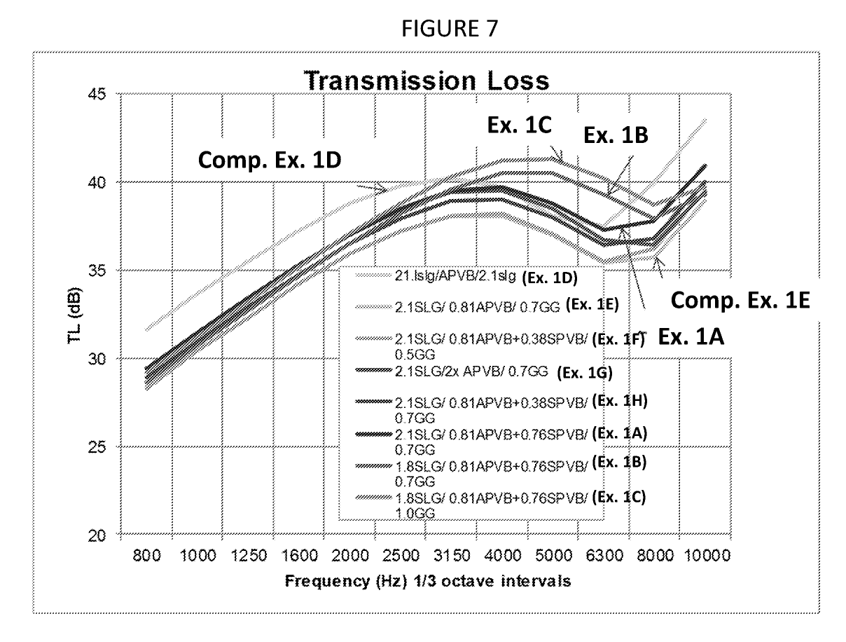

FIG. 7 shows the transmission loss (dB) as a function of frequency (Hz). As shown in FIG. 7, Examples 1A-1C exhibited improved transmission loss (i.e., 38 dB or greater) over a frequency range from about 2500 Hz to about 6000 Hz. Examples 1B and 1C exhibited even higher transmission loss values over a frequency range from about 3150 Hz or 4000 Hz to about 6000 Hz. Comparative Example 1D only exhibited high levels of transmission loss over a frequency range from about 2500 Hz to about 5000 Hz and also has a greater thickness, and thus greater weight, than Examples 1A-1C. Comparative Examples 1E-1H exhibited much lower transmission loss over the frequency range from about 2500 Hz to about 6000 Hz.

### Example 2

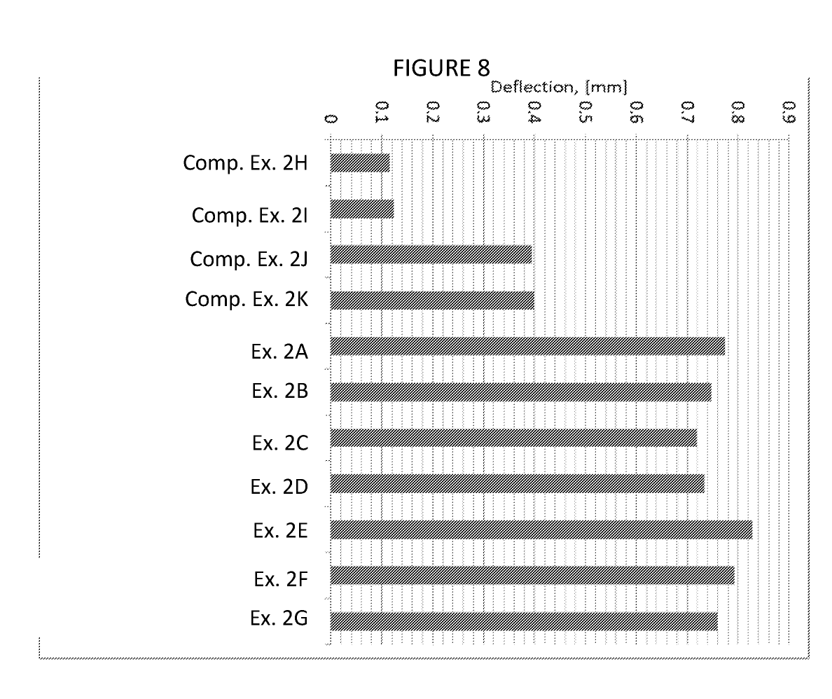

Examples 2A-2G and Comparative Examples 2H-2K were evaluated for mechanical deflection by loading each example on a frame and applying a constant load of 100 N to the center of a major surface of the laminate using a one-half pound stainless steel ball. Examples 2A-2G and Comparative Examples 2H-2K included the constructions described in Table 2. The measured deflection is shown in FIG. 8.

TABLE 1
Constructions of Examples 2A-2G and Comparative Examples 2H-2K.

| | First substrate | | Second substrate |
|---|---|---|---|
| | (type and | Interlayer structure (shear modulus and | (type and |
| Example | thickness) | thickness) | thickness) |
| 2A | Soda-lime | First interlayer: 8.2 × 10⁶ Pa, at 5000 Hz at | Alkali- |
| | silicate, 2.1 mm | 20° C., 0.81 mm | aluminosilicate, |
| | | Second interlayer: None | 0.7 mm |
| | | | (strengthened) |
| 2B | Soda-lime | First interlayer: 8.2 × 10⁶ Pa, at 5000 Hz at | Alkali- |
| | silicate, 2.1 mm | 20° C., 0.81 mm | aluminosilicate, |
| | | Second interlayer: 1.3 × 10⁸, at 20° C. and at | 0.7 mm |
| | | 5000 Hz, 0.38 mm | (strengthened) |
| 2C | Soda-lime | First interlayer: 8.2 × 10⁶ Pa, at 5000 Hz at | Alkali- |
| | silicate, 2.1 mm | 20° C,. 0.81 mm | aluminosilicate, |
| | | Second interlayer: 1.3 × 10⁸, at 20° C. and at | 0.7 mm |
| | | 5000 Hz, 0.76 mm | (strengthened) |
| 2D | Soda-lime | First interlayer: 8.2 × 10⁶ Pa, at 5000 Hz at | Alkali- |
| | silicate, 2.1 mm | 20° C., 0.81 mm | aluminosilicate, |
| | | Second interlayer: 1.3 × 10⁸, at 20° C. and at | 0.7 mm |
| | | 5000 Hz, 0.81 mm | (strengthened) |
| 2E | Soda-lime | First interlayer: 8.2 × 10⁶ Pa, at 5000 Hz at | Alkali- |
| | silicate, 2.1 mm | 20° C., 0.81 mm | aluminosilicate, |
| | | Second interlayer: None | 0.55 mm |
| | | | (strengthened) |
| 2F | Soda-lime | First interlayer: 8.2 × 10⁶ Pa, at 5000 Hz at | Alkali- |
| | silicate, 2.1 mm | 20° C., 0.81 mm | aluminosilicate, |
| | | Second interlayer: 1.3 × 10⁸, at 20° C. and at | 0.55 mm |
| | | 5000 Hz, 0.38 mm | (strengthened) |
| 2G | Soda-lime | First interlayer: 8.2 × 10⁶ Pa, at 5000 Hz at | Alkali- |
| | silicate, 2.1 mm | 20° C., 0.81 mm | aluminosilicate, |
| | | Second interlayer: 1.3 × 10⁸, at 20° C. and at | 0.55 mm |
| | | 5000 Hz, 0.76 mm | (strengthened) |
| Comp. | Soda-lime | First interlayer: 8.2 × 10⁶ Pa, at 5000 Hz at | Soda-lime |
| 2H | silicate, 3.2 mm | 20° C., 0.81 mm | silicate, 3.2 mm |
| | | Second interlayer: None | |
| Comp. | Soda-lime | First interlayer: 8.2 × 10⁶ Pa, at 5000 Hz at | Soda-lime |
| 2I | silicate, 3.2 mm | 20° C., 0.81 mm | silicate, 3.2 mm |
| | | Second interlayer: 1.3 × 10⁸, at 20° C. and at | |
| | | 5000 Hz, 0.76 mm | |
| Comp. | Soda-lime | First interlayer: 8.2 × 10⁶ Pa, at 5000 Hz at | Soda-lime |
| 2J | silicate, 2.1 mm | 20° C., 0.81 mm | silicate, 2.1 mm |
| | | Second interlayer: None | |
| Comp. | Soda-lime | First interlayer: 8.2 × 10⁶ Pa, at 5000 Hz at | Soda-lime |
| 2K | silicate, 2.1 mm | 20° C., 0.81 mm | silicate, 2.1 mm |
| | | Second interlayer: 1.3 × 10⁸, at 20° C. and at | |
| | | 5000 Hz, 0.76 mm | |

Comparative Examples 2H-2K included traditional and symmetrical laminates, which exhibited an increased deflection (i.e., loss in mechanical stiffness) after adding an additional interlayer between the glass layers (compare Comparative Example 2H with Comparative Example 21 and compare Comparative Example 2J and Comparative Example 2K). This behavior is expected and has been reported. Without being bound by theory, it is believed that a thicker polymer interlayer higher results in lower stiffness or increased deflection of the laminate for a given applied load.

For thin asymmetric laminates, modeling indicates an improvement in mechanical stiffness of the laminate with two interlayers (i.e., a first and second interlayer having the shear modulus shown in Table 2). This behavior is characteristic of asymmetric laminates where one substrate is thicker than the other substrate. Thicker interlayer structure have a greater effect in mechanical stiffness where the substrates have greater asymmetry between them.

The effect can also be seen in Examples 2L-2O which have constructions shown in Table 3.

TABLE 3
Constructions of Examples 2L-2O.

| | First substrate | | Second substrate |
|---|---|---|---|
| | (type and | Interlayer structure (shear modulus and | (type and |
| Example | thickness) | thickness) | thickness) |
| 2L | Soda-lime | First interlayer: 8.2 × 10⁶ Pa, at 5000 Hz at | Alkali- |
| | silicate, 1.8 mm | 20° C., 0.81 mm | aluminosilicate, |
| | | Second interlayer: None | 0.7 mm |
| | | | (strengthened) |
| 2M | Soda-lime | First interlayer: 8.2 × 10⁶ Pa, at 5000 Hz at | Alkali- |
| | silicate, 1.8 mm | 20° C., 0.81 mm | aluminosilicate, |
| | | Second interlayer: 1.3 × 10⁸, at 20° C. and at | 0.7 mm |
| | | 5000 Hz, 0.76 mm | (strengthened) |
| 2N | Soda-lime | First interlayer: 8.2 × 10⁶ Pa, at 5000 Hz at | Alkali- |
| | silicate, 1.8 mm | 20° C., 0.81 mm | aluminosilicate, |
| | | Second interlayer: None | 0.55 mm |
| | | | (strengthened) |
| 2O | Soda-lime | First interlayer: 8.2 × 10⁶ Pa, at 5000 Hz at | Alkali- |
| | silicate, 1.8 mm | 20° C., 0.81 mm | aluminosilicate, |
| | | Second interlayer: 1.3 × 10⁸, at 20° C. and at | 0.55 mm |
| | | 5000 Hz, 0.76 mm | (strengthened) |

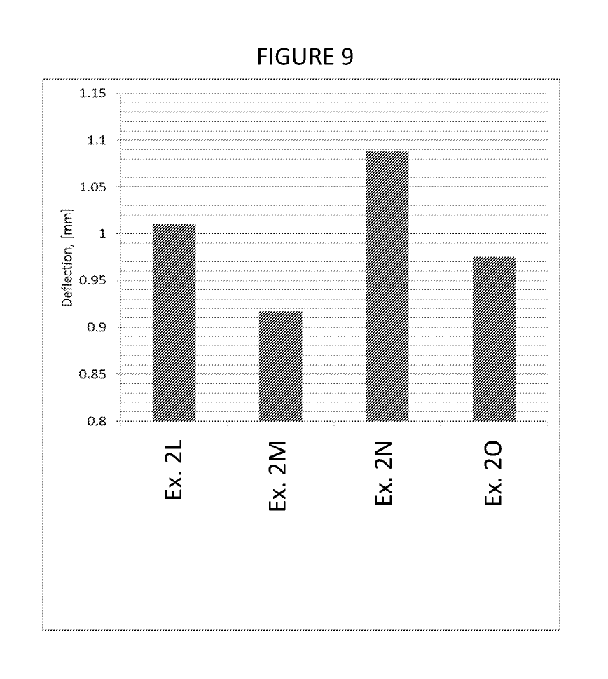

As shown in FIG. 9, asymmetric laminates having an interlayer structure with two sub-layers (with differing shear modulus values) provides improved mechanical performance in terms of increased structural rigidity or stiffness compared to asymmetric laminates with a single interlayer (regardless of shear modulus value). Specifically, Examples 2M and 2O, which include interlayer structures with two sub-layers have decreased deflection compared to Examples 2L and 2N, respectively.

### Example 3

Examples 3A-3B were evaluated to determine the effect of the position of an interlayer structure including only a first interlayer and thickness of the substrate facing the sound source on sound dampening. Example 3A and 3B both included the same interlayer structure (including only a single layer of a first interlayer having the same thickness in each example). Example 3A included a thinner substrate facing the sound source, while Example 3B included a thicker substrate facing the sound source, as shown in Table 4.

TABLE 4
Constructions of Examples 3A-3B.

| | | | Second substrate |
|---|---|---|---|
| | First substrate | | (type and |
| | (type and | | thickness) |
| | thickness) | | Facing away |
| Exam- | Facing the | Interlayer structure | from the sound |
| ple | sound source | (shear modulus) | source |
| 3A | Alkali- | First interlayer: 8.2 × 10⁶ | Soda-lime |
| | aluminosilicate, | Pa, at 5000 Hz at 20° C. | silicate, 2.1 mm |
| | 0.7 mm | | |
| | (strengthened) | | |
| 3B | Soda-lime | First interlayer: 8.2 × 10⁶ | Alkali- |
| | silicate, 2.1 mm | Pa, at 5000 Hz at 20° C. | aluminosilicate, |
| | | | 0.7 mm |
| | | | (strengthened) |

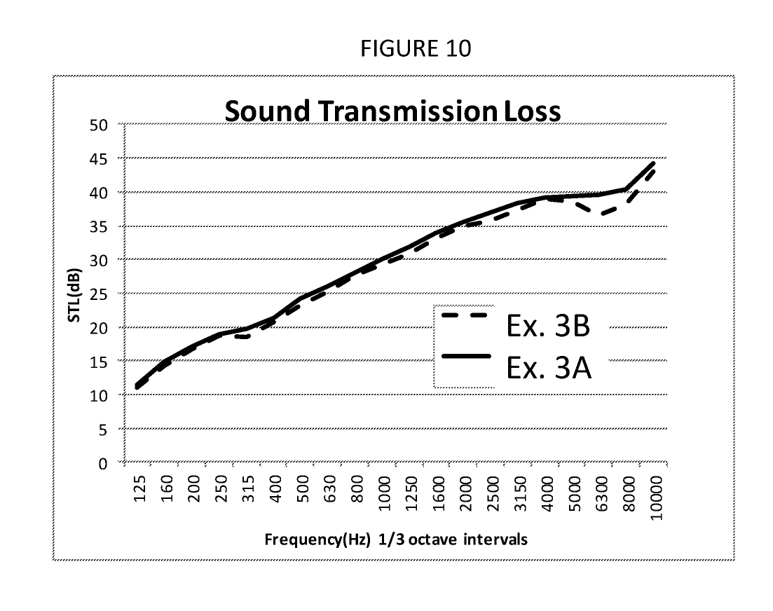

As shown in FIG. 10, when the thinner substrate faces the sound source (as is the case in Example 3A), there is greater transmission loss and thus a greater dampening effect.

Examples 3C and 3D were identical to Examples 3A and 3B, respectively, but included two layers of the first interlayers, as shown in Table 5.

TABLE 5
Constructions of Examples 3C-3D.

| | | | Second substrate |
|---|---|---|---|
| | First substrate | | (type and |
| | (type and | | thickness) |
| | thickness) | | Facing away |
| Exam- | Facing the | Interlayer structure | from the sound |
| ple | sound source | (shear modulus) | source |
| 3C | Alkali- | Double layer of: | Soda-lime |
| | aluminosilicate, | First interlayer: 8.2 × 10⁶ | silicate, 2.1 mm |
| | 0.7 mm | Pa, at 5000 Hz at 20° C. | |
| | (strengthened) | First interlayer: 8.2 × 10⁶ | |
| | | Pa, at 5000 Hz at 20° C. | |
| 3D | Soda-lime | Double layer of: | Alkali- |
| | silicate, 2.1 mm | First interlayer: 8.2 × 10⁶ | aluminosilicate, |
| | | Pa, at 5000 Hz at 20° C. | 0.7 mm |
| | | First interlayer: 8.2 × 10⁶ | (strengthened) |
| | | Pa, at 5000 Hz at 20° C. | |

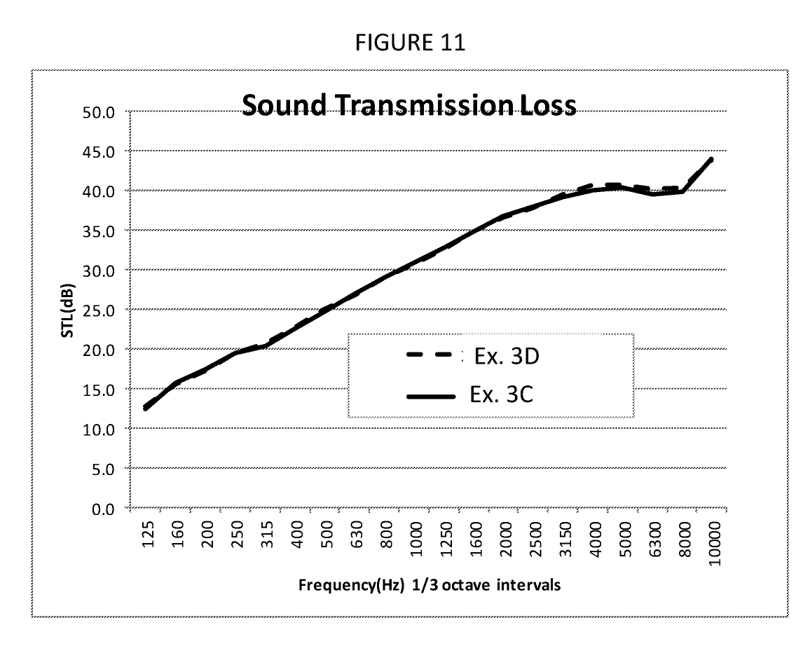

As shown in FIG. 11, the orientation of the interlayer structure does not provide a significant benefit as to whether a thinner or thicker substrate faces the sound source. When comparing FIG. 10 with FIG. 11, Example 3C exhibits a less sound transmission loss at a frequency range of about 6000 Hz to 8000 Hz, when compared to Example 3A; however, Example 3D exhibits a greater sound transmission loss at the same frequency range when compared to Example 3B.

### Example 4

Examples 4A-4D were evaluated to determine the effect of position of an interlayer structure including a first interlayer and a second layer and the relative position of the first interlayer with respect to a given substrate, on sound dampening. The constructions of Examples 4A-4D are shown in Table 6. The first interlayer thickness was the same in each of Examples 4A-4D and the second interlayer thickness was the same in each of Examples 4A-4D.

TABLE 6
Constructions of Examples 4A-4D.

| | | | | Second substrate |
|---|---|---|---|---|
| | First substrate | | | (type and |
| | (type and | | | thickness) |
| | thickness) | | | Facing away |
| | Facing the | | | from the sound |
| Example | sound source | Interlayer structure (shear modulus) | | source |
| 4A | Alkali- | Second interlayer: | First interlayer: | Soda-lime |
| | aluminosilicate, | 1.3 × 10⁸, at 20° C. and | 8.2 × 10⁶ Pa, at 5000 | silicate, 2.1 mm |
| | 0.7 mm | at 5000 Hz (adjacent | Hz at 20° C. | |
| | (strengthened) | to the first substrate) | (adjacent to the | |
| | | | second substrate) | |
| 4B | Soda-lime | First interlayer: | Second interlayer: | Alkali- |
| | silicate, 2.1 mm | 8.2 × 10⁶ Pa, at 5000 | 1.3 × 10⁸, at 20° C. | aluminosilicate, |
| | | Hz at 20° C. | and at 5000 Hz | 0.7 mm |
| | | (adjacent to the first | (adjacent to the | (strengthened) |
| | | substrate) | second substrate) | |
| 4C | Alkali- | First interlayer: | Second interlayer: | Soda-lime |
| | aluminosilicate, | 8.2 × 10⁶ Pa, at 5000 | 1.3 × 10⁸, at 20° C. | silicate, 2.1 mm |
| | 0.7 mm | Hz at 20° C. | and at 5000 Hz | |
| | (strengthened) | (adjacent to the first | (adjacent to the | |
| | | substrate) | second substrate) | |
| 4D | Soda-lime | Second interlayer: | First interlayer: | Alkali- |
| | silicate, 2.1 mm | 1.3 × 10⁸, at 20° C. and | 8.2 × 10⁶ Pa, at 5000 | aluminosilicate, |
| | | at 5000 Hz (adjacent | Hz at 20° C. | 0.7 mm |
| | | to the first substrate) | (adjacent to the | (strengthened) |
| | | | second susbtrate) | |

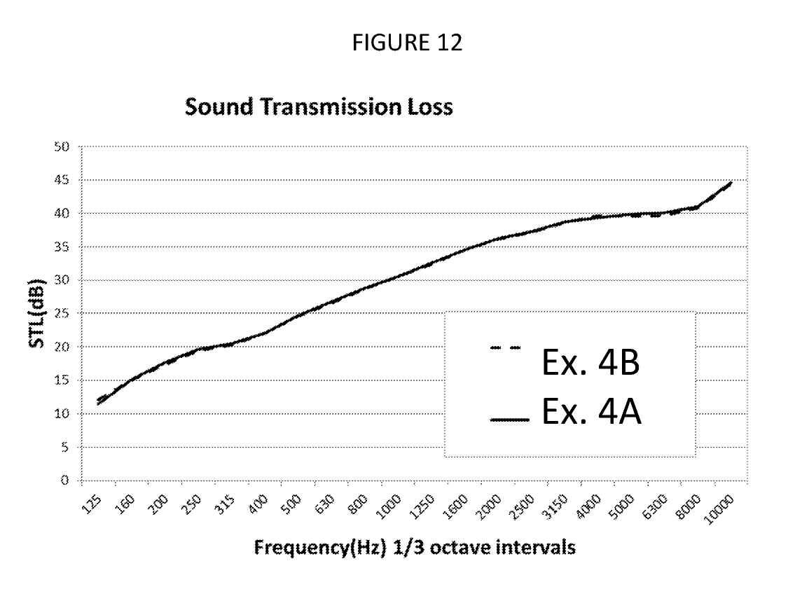

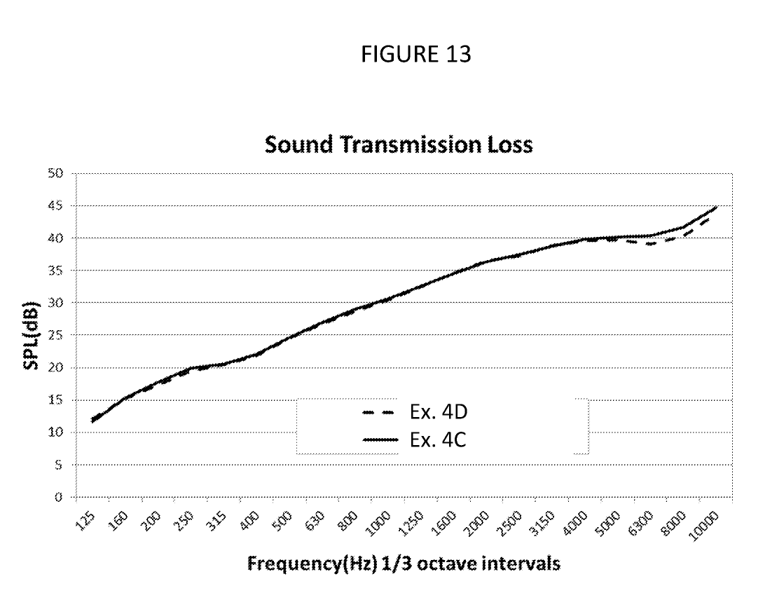

FIGS. 12 and 13 show the sound transmission loss of Examples 3A and 3B, and Examples 3C and 3D, respectively. As shown in FIG. 12, the Examples 4A and 4B exhibited substantially the same sound transmission loss as one another. Comparing Examples 4B and 4D in which the thicker substrate is facing the sound source, the sound transmission loss is also substantially the same. Example 4C exhibited the greatest sound transmission loss and demonstrates that when the first interlayer is positioned closes to the thinner substrate and the thinner substrate faces the sound source, the sound transmission loss of the laminate is improved.

### Example 5

Examples 5A-5E were evaluated to determine the effect the interlayer structure and thickness of the substrate facing the sound source, on sound dampening. The constructions of Examples 5A-5E are shown in Table 7. The first interlayer thickness was the same in each of the Examples and the second interlayer thickness (when utilized) was the same in each of Examples.

TABLE 7
Constructions of Examples 5A-5E.

| | | | | Second substrate |
|---|---|---|---|---|
| | First substrate | | | (type and |
| | (type and | | | thickness) |
| | thickness) | | | Facing away |
| | Facing the | | | from the sound |
| Example | sound source | Interlayer structure (shear modulus) | | source |
| 5A | Soda-lime | First interlayer: | No second interlayer | Alkali- |
| | silicate, 2.1 mm | 8.2 × 10⁶ Pa, at 5000 | | aluminosilicate, |
| | | Hz at 20° C. | | 0.55 mm |
| | | (adjacent to the first | | (strengthened) |
| | | substrate) | | |
| 5B | Soda-lime | First interlayer: | Second interlayer: | Alkali- |
| | silicate, 2.1 mm | 8.2 × 10⁶ Pa, at 5000 | 1.3 × 10⁸, at 20° C. | aluminosilicate, |
| | | Hz at 20° C. | and at 5000 Hz | 0.55 mm |
| | | (adjacent to the first | (adjacent to the | (strengthened) |
| | | substrate) | second substrate) | |
| 5C | Soda-lime | First interlayer: | No second interlayer | Alkali- |
| | silicate, 2.1 mm | 8.2 × 10⁶ Pa, at 5000 | | aluminosilicate, |
| | | Hz at 20° C. | | 0.7 mm |
| | | (adjacent to the first | | (strengthened) |
| | | substrate) | | |
| 5D | Soda-lime | First interlayer: | No second interlayer | Alkali- |
| | silicate, 1.8 mm | 8.2 × 10⁶ Pa, at 5000 | | aluminosilicate, |
| | | Hz at 20° C. | | 0.55 mm |
| | | (adjacent to the first | | (strengthened) |
| | | substrate) | | |
| 5E | Soda-lime | First interlayer: | Second interlayer: | Alkali- |
| | silicate, 1.8 mm | 8.2 × 10⁶ Pa, at 5000 | 1.3 × 10⁸, at 20° C. | aluminosilicate, |
| | | Hz at 20° C. | and at 5000 Hz | 0.55 mm |
| | | (adjacent to the first | (adjacent to the | (strengthened) |
| | | substrate) | second substrate) | |

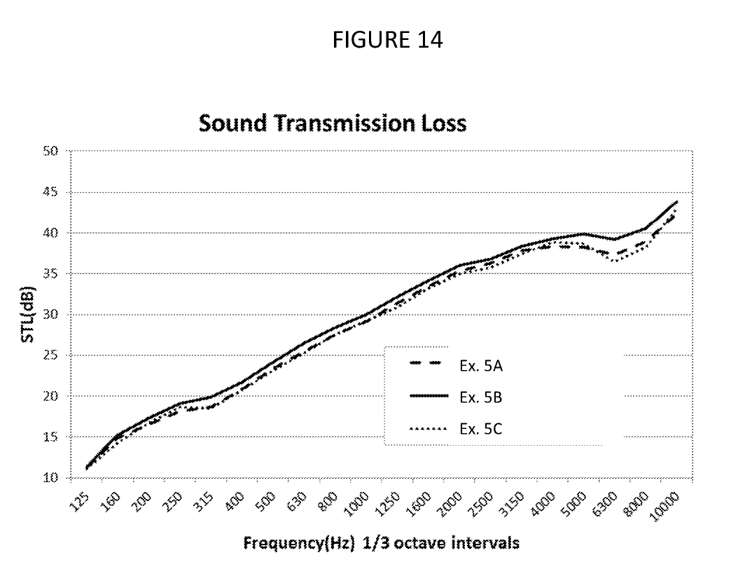

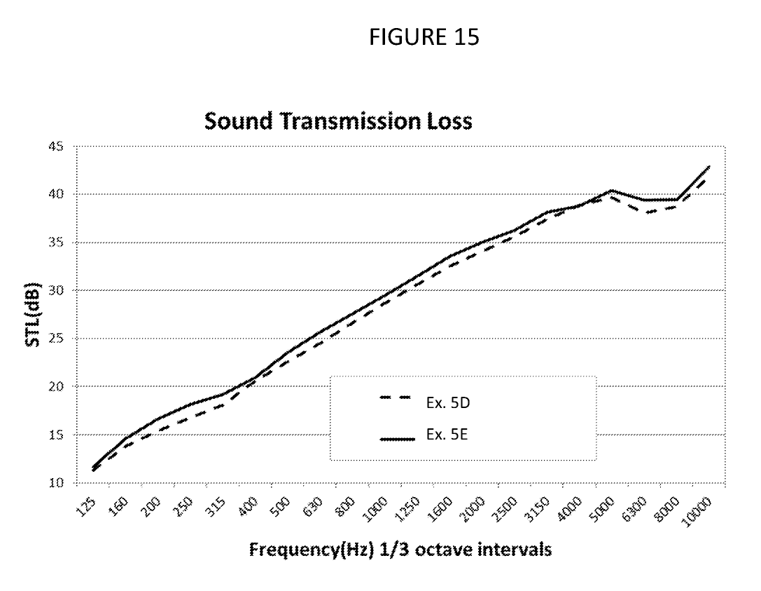

FIGS. 14 and 15 show the sound transmission loss of Examples 5A-5C, and Examples 5D-5E, respectively. As shown in FIG. 14, there is no substantial difference in sound transmission loss when a thicker second substrate is used (i.e., comparing Examples 5A and 5C). However, the addition of a second interlayer (Example 5B) increases sound transmission loss at frequencies of about 4000 Hz and greater. As shown in FIG. 15, the addition of a second interlayer increases sound transmission loss even when the first substrate is thinner.

It will be apparent to those skilled in the art that various modifications and variations can be made without departing from the spirit or scope of the invention.

What is claimed is:

1. A vehicle comprising:
a body having at least one opening and an interior;
a laminate disposed in the at least one opening, the laminate comprising a first substrate, an interlayer structure, and a second substrate comprising a thickness of less than about 1.5 mm,
wherein the second substrate is adjacent to the interior of the body;
wherein the interlayer structure is disposed between the first substrate and the second substrate, and
wherein the laminate exhibits a transmission loss of greater than about 38 dB over a frequency range from about 2500 Hz to about 6000 Hz.

2. The vehicle of claim 1, wherein the laminate exhibits a transmission loss of greater than 40 dB over a frequency range from about 4000 Hz to about 6000 Hz.

3. The vehicle of claim 1, wherein the second substrate comprises a thickness of about 0.7 mm or less.

4. The vehicle of claim 1, wherein the interlayer structure comprises a first interlayer and a second interlayer, the first interlayer comprising a shear modulus and the second interlayer comprising a shear modulus that is greater than the shear modulus of the first interlayer, and
wherein the laminate comprises a thickness t, and the first interlayer is positioned at a thickness range from about 0.4 t to about 0.6 t.

5. The vehicle of claim 4, wherein the second interlayer is disposed between the first interlayer and the second substrate.

6. The vehicle of claim 1, wherein the first substrate comprises a thickness of 2.1 mm or less.

7. The vehicle of claim 1, wherein the first substrate is unstrengthened.

8. The vehicle of claim 1, wherein the first substrate comprises soda lime.

9. The vehicle of claim 1, wherein the first substrate is strengthened.

10. The vehicle of claim 1, wherein either one or both the first substrate and the second substrate are strengthened exhibits a compressive stress in the range from about 50 MPa to about 800 MPa and a depth of compression in the range from about 35 micrometers to about 200 micrometers.

11. The vehicle of claim 1, wherein the thickness of the interlayer is about 1.0 mm or greater.

12. The vehicle of claim 1, wherein the first substrate has a thickness and the ratio of the thickness of the second substrate to the thickness of the first substrate is greater than about 0.2.

13. A laminate comprising:
a first substrate, a first interlayer, a second interlayer, and a second substrate,
wherein either one or both the first substrate and the second substrate have a thickness of less than about 1.5 mm and the laminate has a thickness t, and
wherein the first interlayer has a shear modulus of 40×10⁶ Pa or less, at 30° C. and a frequency of 5000 Hz, wherein the first interlayer is positioned at the thickness range from about 0.4 t to about 0.6 t.

14. The laminate of claim 13, wherein the second interlayer has a shear modulus greater than the shear modulus of the first interlayer.

15. The laminate of claim 13, wherein the first interlayer and the second interlayer have different thicknesses.

16. The laminate of claim 13, wherein the first interlayer is disposed between the first substrate and the second interlayer, and the second interlayer is disposed between the first interlayer and the second substrate.

17. The laminate of claim 16, further comprising a third interlayer disposed between the first substrate and the first interlayer, wherein the third interlayer comprises a shear modulus greater than the shear modulus of the first interlayer.

18. The laminate of claim 17, wherein the second interlayer and the third interlayer comprise either one or both of different thicknesses from one another and different shear modulus from one another.

19. A vehicle comprising a body, an opening and the laminate of claim 13 disposed in the opening.

20. An architectural panel comprising the laminate of claim 13, wherein the panel comprises a window, an interior wall panel, a modular furniture panel, a backsplash, a cabinet panel, or an appliance panel.
